(19) United States
(12) Patent Application Publication
(10) Pub. No.: US 2012/0145272 A1
(43) Pub. Date: Jun. 14, 2012

(54) AIR DUCT

(75) Inventors: Dong Ho Chu, Ansan-city (KR); Jong Hoon Lee, Hwaseong-si (KR); Jong Woo Nam, Seoul (KR)

(73) Assignees: Kia Motors Corporation, Seoul (KR); Hyundai Motor Company, Seoul (KR)

(21) Appl. No.: 13/181,230

(22) Filed: Jul. 12, 2011

(30) Foreign Application Priority Data
Dec. 8, 2010 (KR) 10-2010-0124970

(51) Int. Cl. F16L 9/00

(52) U.S. Cl. 138/111

(57) ABSTRACT

An air duct disposed at a front end module that includes a radiator grille of a vehicle, a bumper cover having an opening, and an intercooler according to various embodiments of the present invention may include a first duct that guides air into the intercooler through the radiator grille, a second duct that guides air into the intercooler through an opening of the bumper cover and is integrally formed with the first duct, and a separation wall formed between the first duct and the second duct.

### CROSS-REFERENCE TO RELATED APPLICATION

This application claims priority to and the benefit of Korean Patent Application No. 10-2010-0124970 filed Dec. 8, 2010, the entire contents of which application is incorporated herein for all purposes by this reference.

### BACKGROUND OF INVENTION

1. Field of Invention

This invention relates to an air duct according to various embodiments. More particularly, the present invention relates to an air duct that is disposed at a front end module of a vehicle.

2. Description of Related Art

A front end module of a vehicle includes a condenser of a air-conditioner, a radiator of a cooling system of an engine, and an intercooler for cooling air of turbo charger of an engine such that the engine system can be cooled by a wind flowing thereinto during a running.

Generally, the condenser is disposed at a most front side, the radiator is disposed at a rear side of the condenser, and the intercooler is disposed at a both sides of the condenser and the radiator in a side by side type of vehicle. And, a cooling fan is disposed at a rear side of the radiator so as to blowing air from the outside to the engine.

Accordingly, wind flows into an opened hole that is formed at a lower portion of a radiator grille and a bumper cover and penetrates the condenser, the radiator, and the intercooler to absorb the heat of the radiator devices, i.e. cool refrigerant, coolant, and intake air.

Meanwhile, the condenser improves an interior air-conditioning performance of a vehicle, the radiator prevents the engine from being overheated, and the intercooler improves a charging efficiency to enhance output of the engine and fuel consumption efficiency.

Accordingly, it is desirable that an opening area of the radiator grill or the bumper cover is enlarged so as to improve the cooling performance of the above radiator devices.

However, the radiator grille and the bumper cover forms a frontal appearance of a vehicle to be a very important factor in an appearance design of a vehicle, and since enlarging the opening area deteriorates a flexibility of a design, further a recent design trend is downsizing the opening area.

Accordingly, because it is difficult to enough enlarging the opening area of the radiator grille and the bumper cover, a cooling performance of the radiator devices is deteriorated, engine output and fuel consumption efficiency is decreased, an air-conditioning performance of a vehicle is also debased, and an engine is not efficiently cooled.

The information disclosed in this Background section is only for enhancement of understanding of the general background of the invention and should not be taken as an acknowledgement or any form of suggestion that this information forms the prior art already known to a person skilled in the art.

### SUMMARY OF INVENTION

Various aspects of the present invention provide for an air duct that is disposed on a front end module of a vehicle having advantages of improving a cooling performance of an intercooler, minimizing a decrease of a cooling performance of a radiator, improving an engine output and fuel consumption efficiency, and securing a cooling performance of the engine without deteriorating a design flexibility of a frontal appearance of a vehicle.

An air duct disposed at a front end module may include a radiator grille of a vehicle, a bumper cover having an opening, and an intercooler according to various embodiments of the present invention may include a first duct that guides wind flowing into the intercooler through the radiator grille, a second duct that guides wind flowing into the intercooler through an opening of the bumper cover and is integrally formed with the first duct, and a separation wall that is formed between the first duct and the second duct.

The air duct may include a catching projection that protrudes an edge of the second duct in a direction that crosses with an inlet of the second duct, and a coupling hole that is formed in a parallel direction with an inlet of the first duct at an edge of the first duct.

The intercooler may include a coupling socket corresponding to the catching projection, wherein the catching projection is inserted into the coupling socket, and the air duct and the intercooler is engaged by a bolt through the coupling hole.

A protruding direction of the catching projection may cross a penetration direction of the coupling hole.

The air duct may include a first blocking portion that covers a part of an inlet of the first duct, and a second blocking portion that covers a part of an inlet of the second duct.

The first blocking portion and the second blocking portion may neighbor from each other and the separation wall is disposed between them.

A reinforcement rib may be formed between the first blocking portion and the second blocking portion.

The reinforcement rib may have a length in a direction that crosses the separation wall.

The first blocking portion and the second blocking portion may be formed on the slant such that wind colliding with the first blocking portion and the second blocking portion flows towards a center direction of the vehicle.

The air duct may include a first guide portion that is extended from an inlet of the first duct, and a second guide portion that is extended from an inlet of the second duct.

The first guide portion may cover an area less than 40% of the entire area of the radiator grille.

The air duct according to various embodiments of the present invention effectively improves cooling performance of the intercooler of the vehicle.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a perspective view showing a bottom of an exemplary air duct according to the present invention.

FIG. 2 is a front view showing a condition that an air duct of FIG. 1 and an intercooler are combined.

FIG. 3 is a side view showing a condition that an air duct of FIG. 1 and an intercooler are combined.

FIG. 4 is a front view of a vehicle mainly showing a condition that an air duct of FIG. 1 is disposed therein.

FIG. 5 is a top plan view of a vehicle mainly showing a condition that an air duct of FIG. 1 is disposed therein.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

Also, the same reference numerals will be used for the same or similar elements throughout the specification.

In the drawings, size and thickness of each element is approximately shown for better understanding and ease of description. Therefore, the present invention is not limited to the drawings.

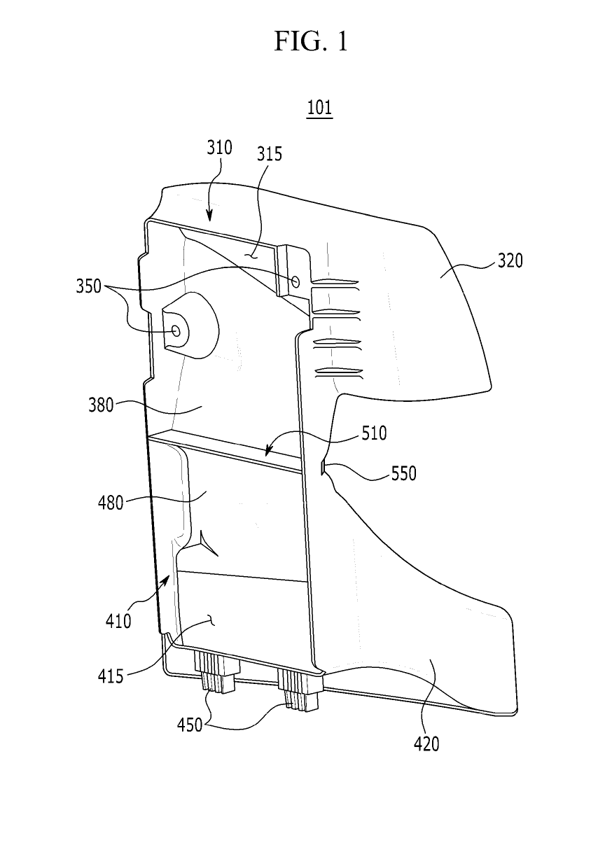

Hereinafter, referring to FIG. 1 to FIG. 3, an air duct 101 according to various embodiments of the present invention is explained.

As shown in FIG. 1, the air duct 101 includes a first duct 310, a second duct 410, a separation wall 510, a catching projection 450, and a coupling hole 350.

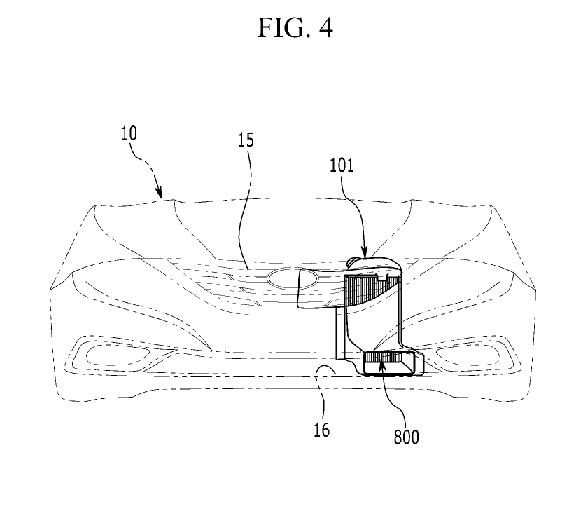

The first duct 310 induces wind flowing into the intercooler 800 through a radiator grille (15 of FIG. 4). And, the second duct 410 induces wind flowing into the intercooler 800 through an opening (16 of FIG. 4) of the bumper cover.

The first duct 310 and the second duct 410 are integrally and/or monolithically formed, the separation wall 510 is formed between the first duct 310 and the second duct 410. The separation wall 510 prevents that wind guided by the first duct 310 and wind guided by the second duct 410 collides with from each other. That is, the separation wall 510 minimizes a flowing interference to improve cooling performance of the intercooler 800.

The catching projection 450 protrudes from an edge of the second duct 410 in a direction that crosses the inlet 415 of the second duct 410. The coupling hole 350 is formed in parallel with the inlet 315 of the first duct 310. In this case, a protrusion direction of the catching projection 450 and a penetration direction of the coupling hole 350 crosses from each other.

Also, the air duct 101 further includes a first blocking portion 380 that covers a part of the inlet 315 of the first duct 310 and a second blocking portion 480 that covers a part of the inlet 415 of the second duct 410. The first blocking portion 380 and the second blocking portion 480 neighbor and a separation wall 510 is disposed between them.

The first blocking portion 380 and the second blocking portion 480 are formed on the slant such that wind colliding with the first blocking portion 380 and the second blocking portion 480 flows in a central direction of a vehicle that a radiator or a condenser is disposed.

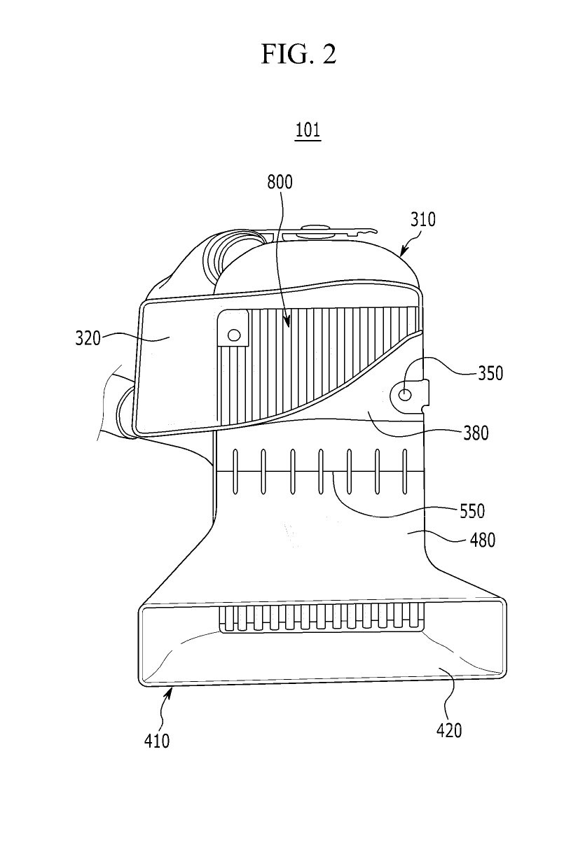

Also, as shown in FIG. 2, the air duct 101 further includes a reinforcement rib 550 that is formed between the first blocking portion 380 and the second blocking portion 480. The reinforcement rib 550 has a length that is formed in a direction that crosses the separation wall 510. The reinforcement rib 550 reinforces a rigidity of the air duct 101 so as to prevent the air duct 101 from being twisted by the wind in a structure that the first duct 310 and the second duct 410 are integrally and/or monolithically formed.

Also, the air duct 101 further includes a first guide portion 320 that is extended from the inlet 315 of the first duct 310 and a second guide portion 420 that is extended from the inlet 415 of the second duct 410. The first guide portion 320 and the second guide portion 420 guide wind such that the wind effectively flows into the first duct 310 and the second duct 320 through each opening 16 of the radiator grille 15 and the bumper cover.

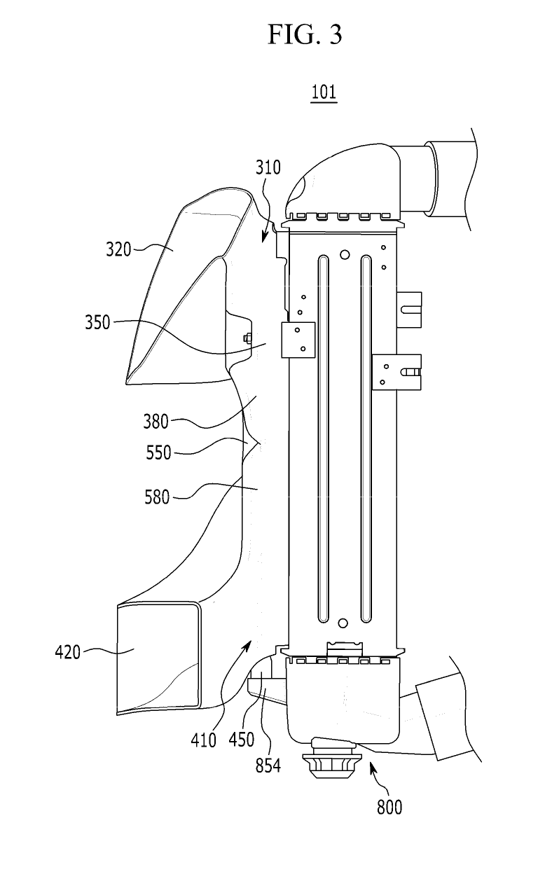

Also, as shown in FIG. 3, the intercooler 800 that is cooled by the air duct 101 according to various embodiments of the present invention includes a coupling socket 854. The catching projection 450 of the air duct 101 is inserted into the coupling socket 854 of the intercooler 800. And, the first duct 310 of the air duct 101 is combined with the intercooler 800 through the coupling hole 350 by a screw bolt.

Like this, the air duct 101 is combined with the intercooler 800 through the catching projection 450 and the coupling hole 350. And, a protrusion direction of the catching projection 450 and a penetration direction of the coupling hole 350 cross each other such that the air duct 101 is combined with the intercooler 800 through union axes of two directions. Accordingly, the air duct 101 is securely supported by the intercooler 800 to be united with the intercooler 800 easily. Also, vibration can be suppressed in a condition that the air duct 101 and the intercooler 800 are engaged from each other.

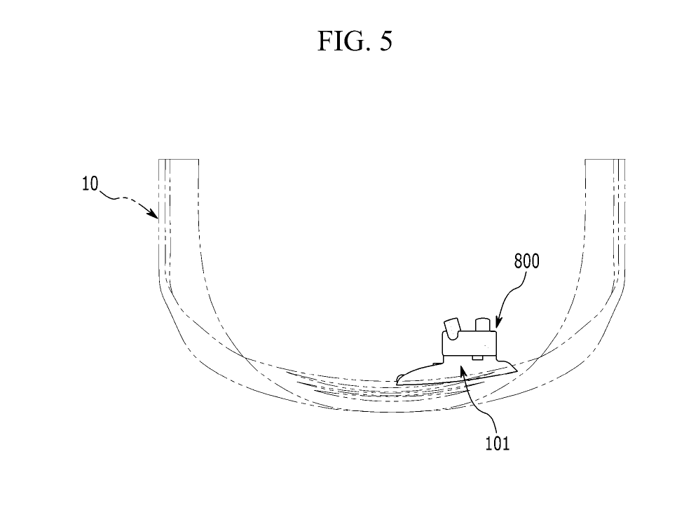

FIG. 4 and FIG. 5 show that the air duct 101 is disposed in the vehicle.

The front end module of the vehicle includes a radiator grille 15, a bumper cover having an opening 16, an intercooler 800, and an air duct 101. And, not shown, but the front end module can include a radiator, a condenser, etc.

Meanwhile, as shown in FIG. 4, the first guide portion 310 of the air duct 101 covers an area narrower than 40% of the entire area of the radiator grille 15. If the first guide portion 310 covers too much area of the radiator grille 15, the wind flowing toward the radiator through the radiator grille 15 decreases to deteriorate cooling performance of the radiator.

By this configuration, the air duct 101 according to various embodiments of the present invention effectively improves a cooling performance of the intercooler 800 of the vehicle. Also, this invention minimizes a decrease of cooling performance of the radiator. Accordingly, the output of the engine and the fuel consumption efficiency are improved to secure a cooling performance of the engine.

For convenience in explanation and accurate definition in the appended claims, the terms lower, front or rear, and etc. are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the claims appended hereto and their equivalents.

What is claimed is:

1. An air duct disposed at a front end module that includes a radiator grille of a vehicle, a bumper cover having an opening, and an intercooler, the air duct comprising:
a first duct that guides air into the intercooler through the radiator grille;
a second duct that guides air into the intercooler through an opening of the bumper cover and is integrally formed with the first duct; and
a separation wall formed between the first duct and the second duct.

2. The air duct of claim 1, further comprising:
a catching projection that protrudes along an edge of the second duct in a direction that crosses with an inlet of the second duct; and
a coupling hole formed in a parallel direction with an inlet of the first duct at an edge of the first duct.

3. The air duct of claim 2, wherein the intercooler includes a coupling socket corresponding to the catching projection, wherein the catching projection is inserted into the coupling socket, and the air duct and the intercooler is engaged by a bolt through the coupling hole.

4. The air duct of claim 3, wherein a protruding direction of the catching projection crosses a penetration direction of the coupling hole.

5. The air duct of claim 1, further comprising
a first blocking portion that covers a part of an inlet of the first duct, and
a second blocking portion that covers a part of an inlet of the second duct.

6. The air duct of claim 5, wherein the first blocking portion and the second blocking portion neighbors from each other and the separation wall is disposed between them.

7. The air duct of claim 6, wherein a reinforcement rib is formed between the first blocking portion and the second blocking portion.

8. The air duct of claim 7, wherein the reinforcement rib has a length in a direction that crosses the separation wall.

9. The air duct of claim 5, wherein the first blocking portion and the second blocking portion is formed on the slant such that wind colliding with the first blocking portion and the second blocking portion flows towards a center direction of the vehicle.

10. The air duct of claim 5, further comprising
a first guide portion extending from an inlet of the first duct, and
a second guide portion extending from an inlet of the second duct.

11. The air duct of claim 10, wherein the first guide portion covers an area less than 40% of the entire area of the radiator grille.
